(19) United States
(12) Patent Application Publication
(10) Pub. No.: US 2008/0215399 A1
(43) Pub. Date: Sep. 4, 2008

(54) Method for Business Process Mapping, Design, Analysis and Performance Monitoring

(76) Inventors: Kaan Kudsi Katircioglu, Yorktown Heights, NY (US); Thomas Robert Ervolina, Poughquag, NY (US)

Correspondence Address: Whitham, Curtis, & Christofferson, P.C., Suite 340, 11491 Sunset Hills Road, Reston, VA, 20190, US

(21) Appl. No.: 12/060,960

(22) Filed: Apr. 2, 2008

Related U.S. Application Data
(63) Continuation of application No. 10/994,231, filed on Nov. 23, 2004.

(51) Int. Cl. G06F 17/00

(52) U.S. Cl. 705/7

(57) ABSTRACT

A method of creating a systems requirement document by using a numerical modeling tool, such as a spreadsheet, to prototype an operational process in terms of a numerical picture of the goals, metrics, performance targets and constraints used by managers of the operational process. A process design blueprint is defined for the operational process, including data sources and data sinks. A representative model of the process design blueprint is created. If the model is not detailed enough for implementation by IT professionals, model objects and data flows are added to the blueprint and the representative model is modified to be consistent with the blueprint. Surrogate calculations may be made for computational task objects or, alternatively, separate process design blueprints may be generated for such computational task objects. This cycle is repeated until the model is detailed enough for implementation.

### BACKGROUND OF THE INVENTION

1. Field of the Invention

The present invention generally relates to methodologies for an operational unit to define its automation requirements, and more particularly to a single pass iterative methodology for assuring that the information technology (IT) requirements document generated by the operational unit is specified in terms which are numerically well defined and therefore can be implemented by IT staff without further input by the operational unit. The method can be used for automating any process whose component elements can be well defined by numeric inputs and outputs.

2. Background Description

As businesses are becoming more and more complex, in the way they are organized and the way they manage their operations, there is more need for a methodology that can reliably translate operational processes into a form that is without ambiguity from the viewpoint of the IT staff called upon to provide automated support to an operational process.

U.S. Pat. No. 6,662,355 to Caswell, et al. (“Caswell”) describes a method and system for specifying and implementing automation of business processes. This method defines and uses basic elements called Information, Function, Flow. Using these elements, processes can be designed and a single shared model can be developed for both business and technical communities. The model includes specifications of each task included in the business model. The entire process to be modeled or designed can be modularized using this method and its elements with defined external specifications. Although the invention described and claimed hereafter also addresses process design it does not bring a new method of designing a process. From this perspective, one can use any known methods or techniques to create the design. The present invention focuses on articulating the details of the technical data requirements underlying the process design and how the data have to be manipulated at key stages of the process where data manipulation occurs. It provides a view of sample data at each stage of the process and uses this to communicate data requirements to the technical people. It also provides formulas that have to be used to manipulate the data. Then, it provides a mechanism through which database tables can be created representing the form of data at each stage of the process.

U.S. Pat. No. 6,091,893 to Fintel, et al. (“Fintel”) describes a method for performing operations on informational objects by visually applying the processes defined in utility objects in an IT (information technology) architecture visual model. It provides an automated system and method for system architects to design model based architectures of information systems. The model based architecture mentioned in Fintel is a system architecture designed from modular hardware and software component models and validated through performance modeling. Embodiments of the automated system and method may be implemented in computer aided design tools utilized by system architects. The focus in this invention is to create an automated system that consists of both hardware and software components and the intended users are system architects. The focus is technical but not the business process design aspect of creating a business solution.

U.S. Patent Publication 20020049573 to El Ata, Nabil A. Abu (“Nabil El Ata”) describes an automated system and method for designing model based architectures of information systems. Nabil El Ata has a method for creating business process design. The method consists of a series of graphical user interfaces through which an initial system architecture for a business process design is constructed. Upon providing the business process design, embodiments of the automated system provide a selectable list of pre-modeled business applications, which are coupled to a set of default hardware and software component models. The initial model is constructed by simply mapping the available business applications to corresponding business processes defined in the business process design. This invention is about putting together existing applications in a system to satisfy business requirements. It does not provide a method to communicate the business process and the business requirements to the technical people and allow them to create database tables that are needed to create the solution that will implement the designed business process. Instead, Nabil El Ata creates the application and a system from existing applications.

U.S. Patent Publication 20040143470 to Myrick, et al. (“Myrick”) describes a method and structure for modeling frameworks and architecture in support of a business, which can eliminate or reduce disadvantages and problems associated with conventional business and IT modeling techniques. The method identifies manageable entities of the business and presents an overall architecture for a business that defines how the manageable entities relate to each other with six components: strategic plan, business architecture, information architecture, application architecture, technology infrastructure architecture, and enterprise information technology management framework. A common language is implemented in order to articulate the overall architecture. Technology requirements for the business are analyzed, planned for, and implemented according to the overall architecture.

U.S. Pat. No. 6,073,109 to Flores, et al. (“Flores”) describes a computerized method and system for managing business processes using linked workflows. Flores is a method and system having a unified tool for conducting business process analysis, design, documentation and to generate business process definitions and workflow-enabled applications. The invention uses two sets of tools: graphical tools used to map out business processes; tools to document and specify the attributes of each workflow definition, including roles, cycle time, conditions, of satisfaction, cost and value, associated text, forms, application data as well as detail the attributes of links between workflows required to complete a business process map, and to generate a business process definition and a workflow-enabled application. In this manner, the invention provides the capability of performing application generation and generation of business process definitions in a definitions database. Flores refers to U.S. Pat. Nos. 5,216,603 and 5,208,748, both owned by Action Technologies, Inc. These patents have similar focus with the limitation that they are limited to single workflows with no capability for mapping business processes made up of a number of workflows linked together.

Although Flores and the inventions cited therein define data field names and set their attributes for each workflow in the process design, and sets attributes of application data fields for forms used by workflow participants, they do not use representative input sample data, representative calculation engines and representative output data. They also do not measure impact of the process design on business performance evaluation. They are more interested in measuring the performance of the IT system that is used to implement the process. Therefore, they collect data about the application that will be used to perform the tasks or activities. They are not concerned with operational and financial business key performance indicators that will be impacted by the process design and some exogenous variables that impact business. No do they do risk analysis or scenario analysis by simulating the model and tracking the performance under different values that exogenous parameters can take.

Under current state-of-the-art it is well known that a requirements document suitable for implementation by IT staff must be unambiguous. Otherwise the IT staff must either resolve the ambiguity themselves or return to the business unit for guidance. What happens in practice is that the business unit prepares the requirements document without a clear understanding of what the term “ambiguous” means for the IT staff. This happens notwithstanding consultations with the IT staff. The typical result is a requirements document that has so exhausted the business unit in its preparation that the IT staff charged with implementation must resolve ambiguities on its own. However, just as the business unit does not understand what the term “ambiguous” means, the IT staff does not understand the operational process of the business unit. The result is an implementation that does not perform in the manner hoped for by the business unit. Modifications to the implementation after the initial resolution of “ambiguities” by the IT staff are often costly and ineffective.

What is needed is a methodology that a business unit can follow which will insure resolution of IT ambiguities during the preparation of the requirements document. There are many methodologies in the prior art which are designed to produce workable software. Object Oriented Design (OOD) is one example. However, many of these methodologies use tools and terminology which are not understood by the business units whose requirements are to be implemented by the software. Consequently, the objective of software which not only works and is robust from an IT perspective but also works and is robust from the perspective of the business unit has proved to be elusive.

### SUMMARY OF THE INVENTION

It is therefore an object of the present invention to provide a new methodology for generating a specification of IT requirements that can be used to understand and articulate a business process without ambiguities.

It is a further object of the invention to provide a framework for describing an operational process which speaks the language of the business unit and at the same time does so in terms which are unambiguous to IT staff.

The method of this invention specifies a Business Process Design (BPD) in response to a business need. The invention specifies the BPD in the form of a Business Process Design Blueprint (BPDB). The method involves the creation of a Representative Model (RM). The RM is a functioning prototype of the BPDB which gives proof that the BPDB is well defined, unambiguous, meets the business need, and has sufficient detail such that an IT System implementer can implement a system that can support the BPD.

Both the business unit and the IT staff understand numbers. In many operational processes, the business unit measures its own performance within the scope of its particular business by means of numbers. Supplies and materials, of various quantities and descriptions, are used as input by a business unit having personnel, tools and other resources to produce products of various kinds. In many circumstances all these inputs, resources and outputs are not only quantifiable in terms of numbers but these numbers are used by the business unit in their day-to-day operations to construct a picture of how well they are performing and what they can change to do a better job. While the business unit does not always have a numerical picture of what it does down to the smallest detail, it does have a numerical picture at the higher levels and, indeed, may focus rather intently upon at least this high level numerical picture of its business.

The methodology of the invention begins and ends with this numerical picture, structuring a requirements definition process which fleshes out the numbers in an iterative fashion, using data to test a representative model of the operational process, until the numerical picture is sufficiently accurate and detailed to satisfy the business unit. By beginning with a numerical picture usable by the business unit, and iteratively expanding this picture, the business unit maintains its focus on numbers which make sense to its mission. In the course of this process, the business unit may add and numerically refine objects which correspond to the way they operate the business. The numbers provide clarity for a requirements document that may otherwise be ambiguous. The numbers also clarify and may prompt changes in the operational process itself. At the end of this process, the numerically defined objects and data flows serve as a requirements document which can be understood unambiguously by IT staff.

According to the invention, there is provided a methodology to map out all or some part of an existing operational process, to design a new operational process, to analyze the process, and to set control guidelines for the purpose of monitoring the process. The methodology is comprehensive in that it captures the links between the component processes at a high level for executive management review and decision making as well as low level data elements and calculations for operational purposes. It can incorporate engines that may perform complex mathematical calculations and can simulate the role of such engines for the other parts of the process.

An aspect of the invention is a method for specifying information technology (IT) requirements for a business process. The method creates a representative model (RM) of the business process, which replicates numerical output measures used by managers to measure performance of the business process. Then raw inputs and calculation engines are added in order to produce intermediate outputs for replicating the numerical output measures. A further step is evaluating whether the representative model is a viable prototype of the business process, and whether it provides desired performance of output measures, and whether its detail is sufficient to enable IT professionals to build a system implementing the prototype. If not, then further detail is added to the representative model and the evaluation step is repeated.

Another way of looking at the method of the invention is to consider its application to an operational process having well defined goals, metrics, performance targets, and constraints. The method specifies information technology (IT) requirements in a way so that they will be unambiguous and usable by IT professionals to build an automated system for the operational process, and yet during the method retain the perspective of the managers. The method begins by defining a process design blueprint for the operational process, comprised of model objects connected by data flows, and also defining data sources and data sinks for the model objects. A numerical modeling tool is used to create data inputs and data outputs for a representative model of the operational process, implementing computational tasks corresponding to said model objects so as to generate thedesired data outputs from expected data inputs, the data inputs and data outputs being responsive to the well defined goals, metrics, performance targets, and constraints used by business managers of the operational process. If the process design blueprint is not detailed enough to specify requirements usable by IT professionals, then additional steps are iterated until the level of detail is sufficient. Model objects and data flow arcs are added to the process design blueprint; the numerical modeling tool is used to create further data inputs and data outputs and implement further computational tasks corresponding to the additional model objects and data flow arcs; and computational task objects are expanded by making surrogate calculations for these tasks or generating separate process design blueprints for these tasks. Then the representative model is evaluated against the goals, metrics, performance targets and constraints of the operational process.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow diagram showing the process methodology for generating an unambiguous requirements document according to the invention.

FIG. 2A is a diagram showing an implementation of the invention for an inventory optimization process, according to steps 1 through 4 of FIG. 1.

FIG. 2B is a diagram showing creation of data for a representative model, i.e. step 4 of the implementation described in FIG. 2A.

FIGS. 2C through 2N show the detail behind the objects shown in FIG. 2B.

FIG. 3 is a diagram showing an automated database creation process in accordance with the invention.

### DETAILED DESCRIPTION OF A PREFERRED EMBODIMENT OF THE INVENTION

The method of this invention specifies a Business Process Design (BPD) in response to a business need. The invention specifies the BPD in the form of a Business Process Design Blueprint (BPDB). The method involves the creation of a Representative Model (RM). The RM is a functioning prototype of the BPDB which gives proof that the BPDB is well defined, unambiguous, meets the business need, and has sufficient detail such that an IT System implementer can implement a system that can support the BPD.

In executing the method of the invention the following steps will be performed. The preliminary steps are common to prior art techniques. First, determine the scope of business activity (hereafter “BP Scope”) for which a “blue print” is needed and identify the set of processes that are involved. Next, define the environment of the business activity. This definition includes such things as (a) goals, (b) metrics, (c) performance targets, (d) business criteria, and (e) constraints. In each process, the group of tasks that make up the process, and their relations, are identified.

In accordance with the invention, each task is represented as an object in the BPDB. For each object, the following three elements are identified: (a) the input information, (b) the decision made or operation performed (i.e., decision objective, rules and constraints, and metrics), and (c) the output information. These three elements comprise the “data model” for the object.

An integrated, end-to-end example representation of the process is made in a spreadsheet or any other tool that is convenient. This example or Representative Model (RM) should depict (a) a representation for each process involved, (b) a representation of each key task in each process, (c) a representation of data elements that are used in each task, (d) calculations performed in each task, and (e) a representation of the output of the calculation. Several examples are made for different cases that need to be captured. Random number generators are attached for input parameters that are random. Calculation engines are attached for complex mathematical calculations. Several cases are generated and statistics collected on the performance metrics (if analysis is needed). Finally, control limits are set for the metrics of interest based on the above statistics (for performance monitoring).

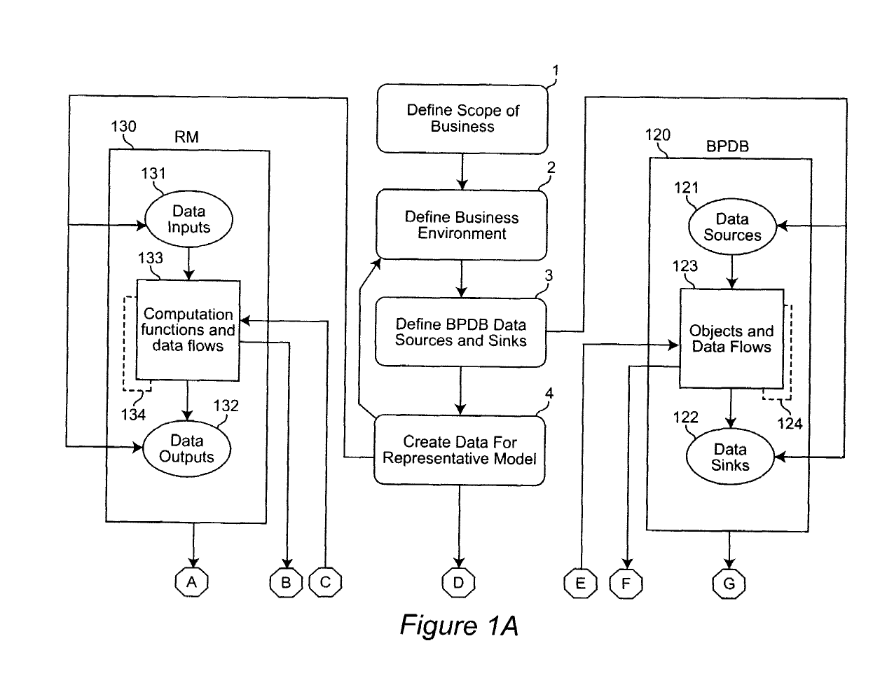

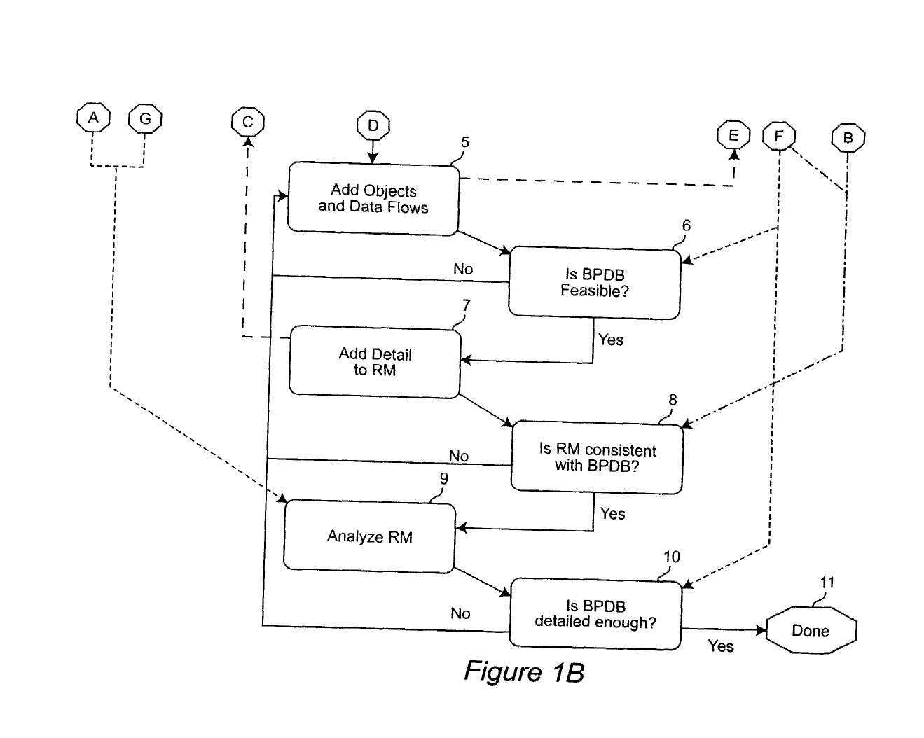

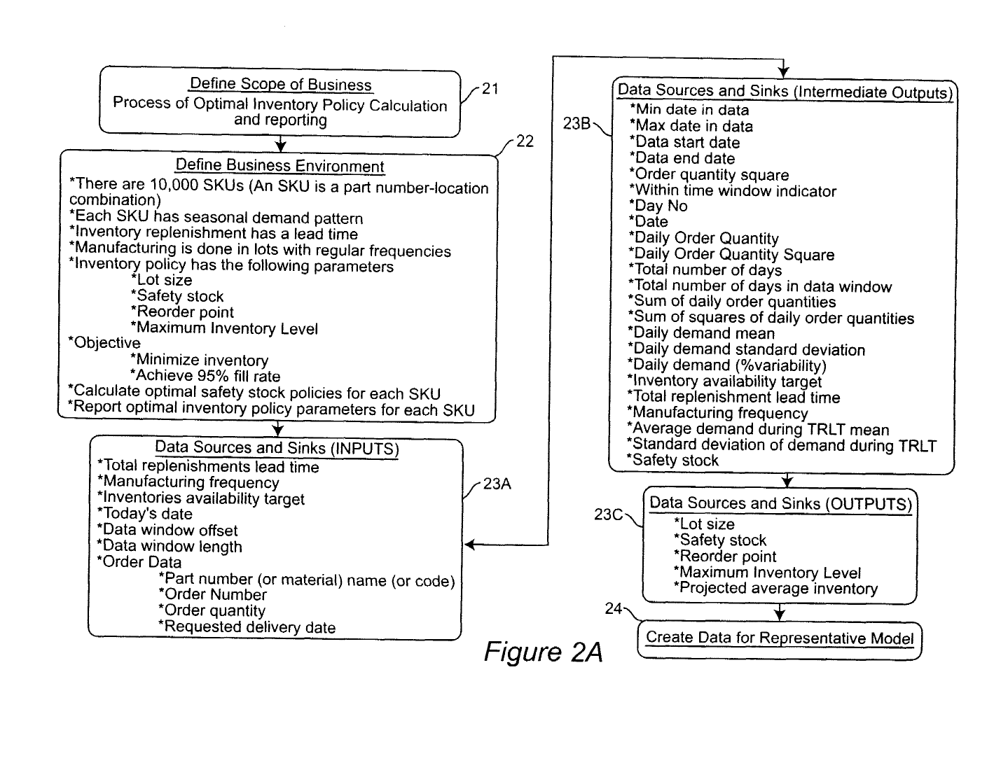

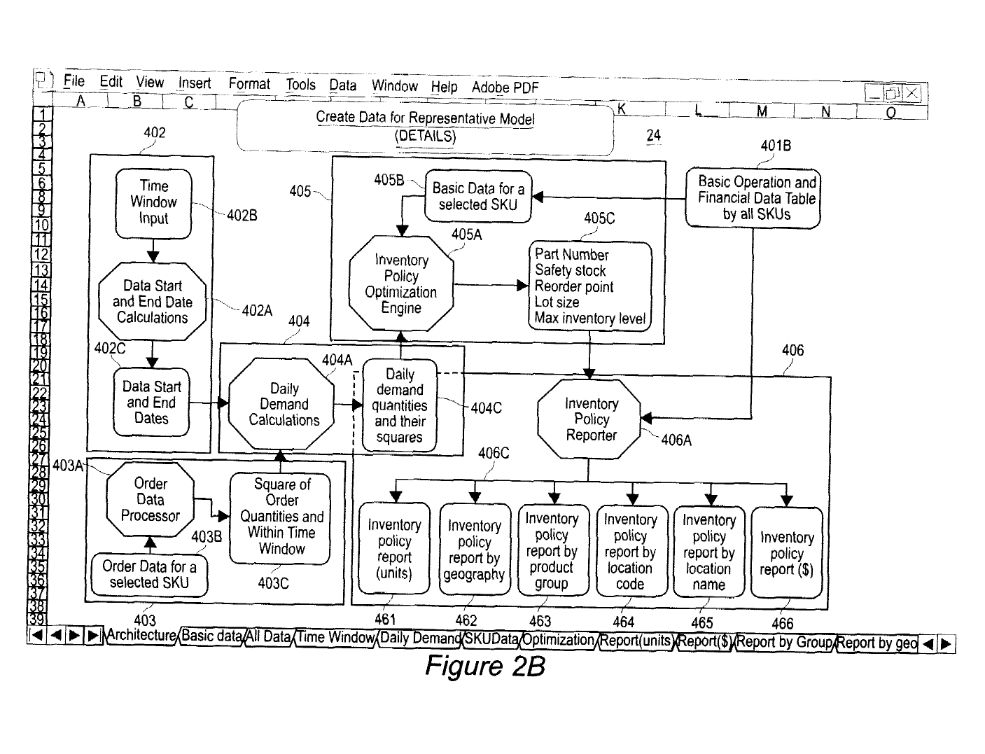

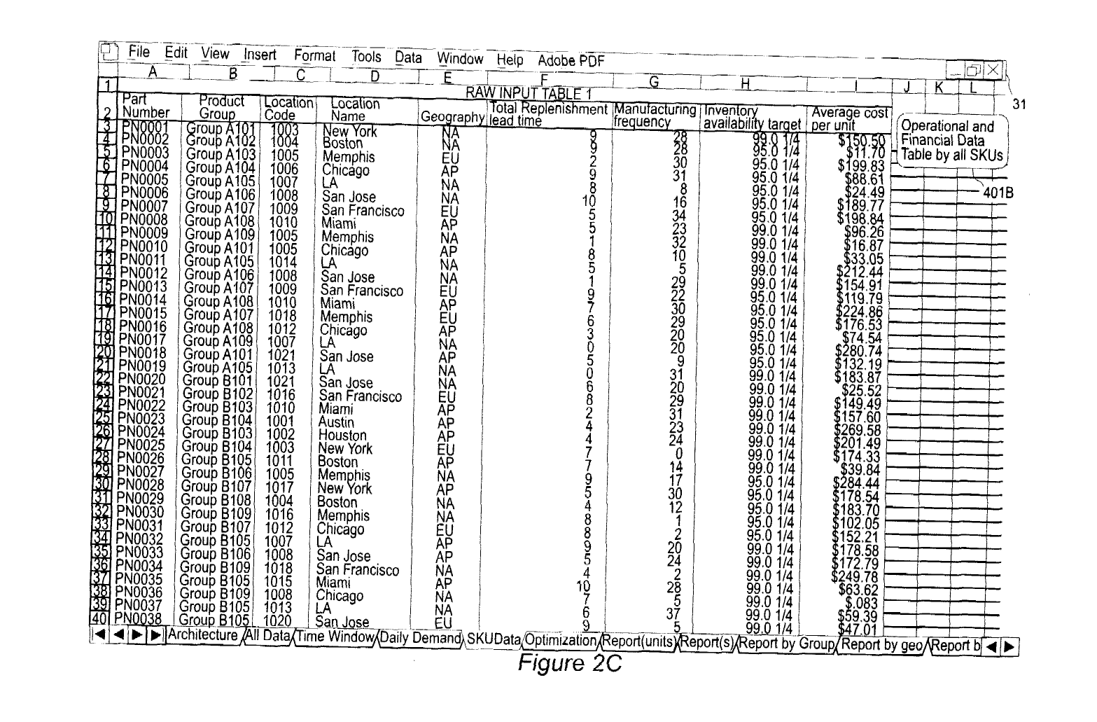

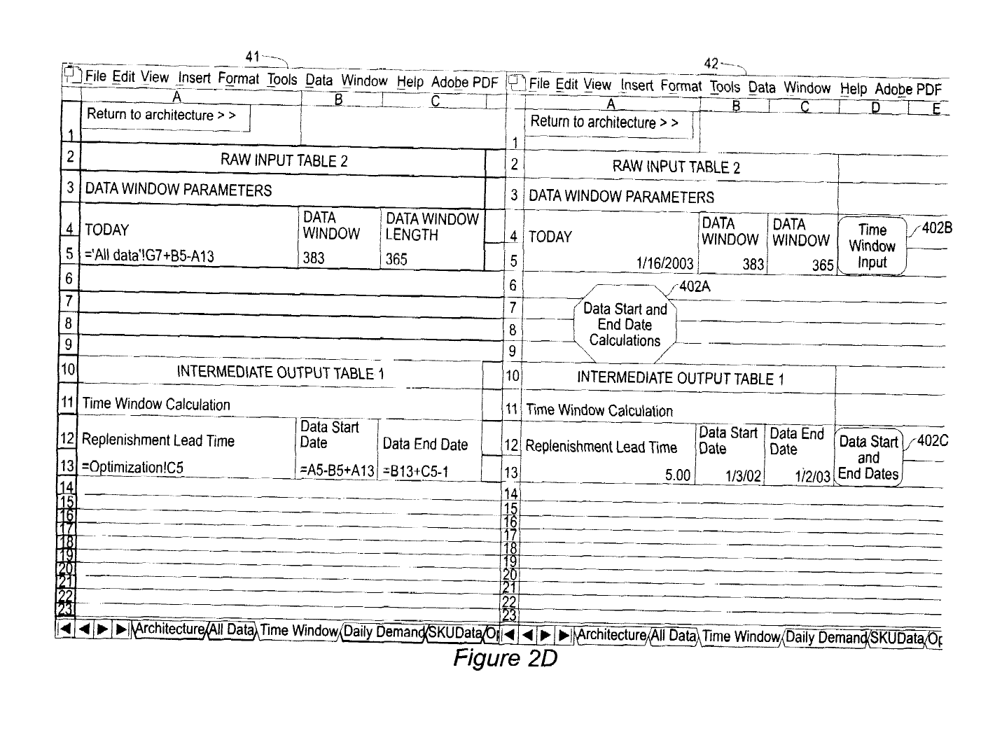

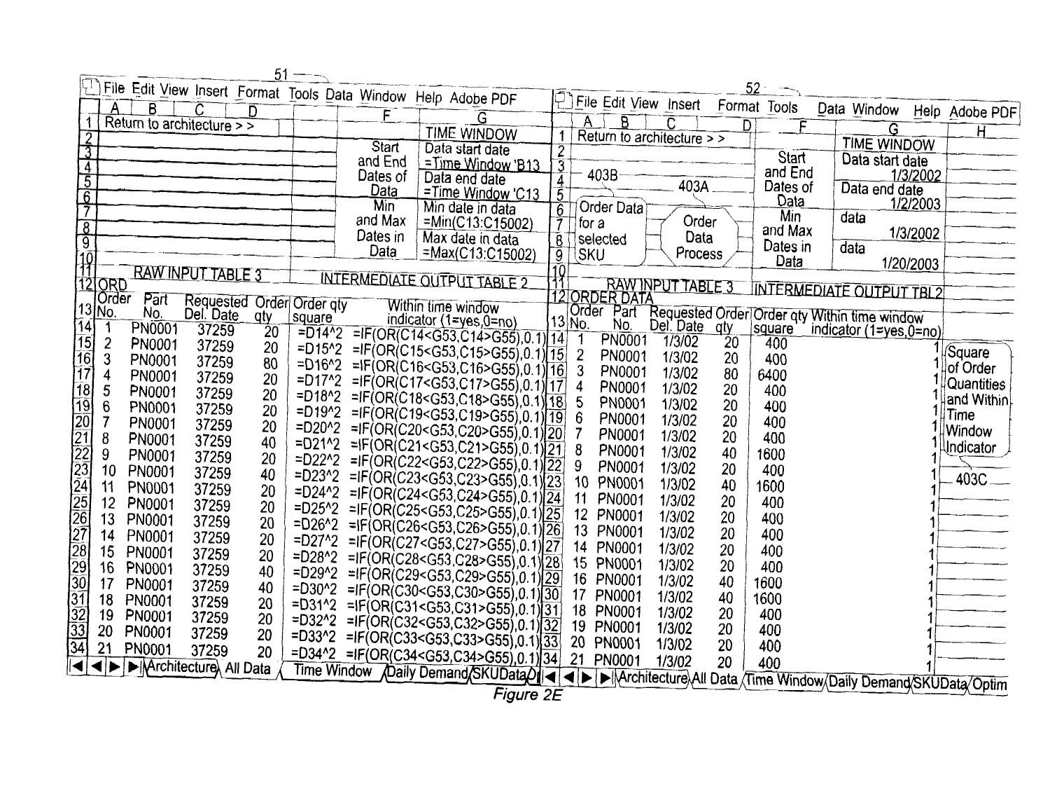

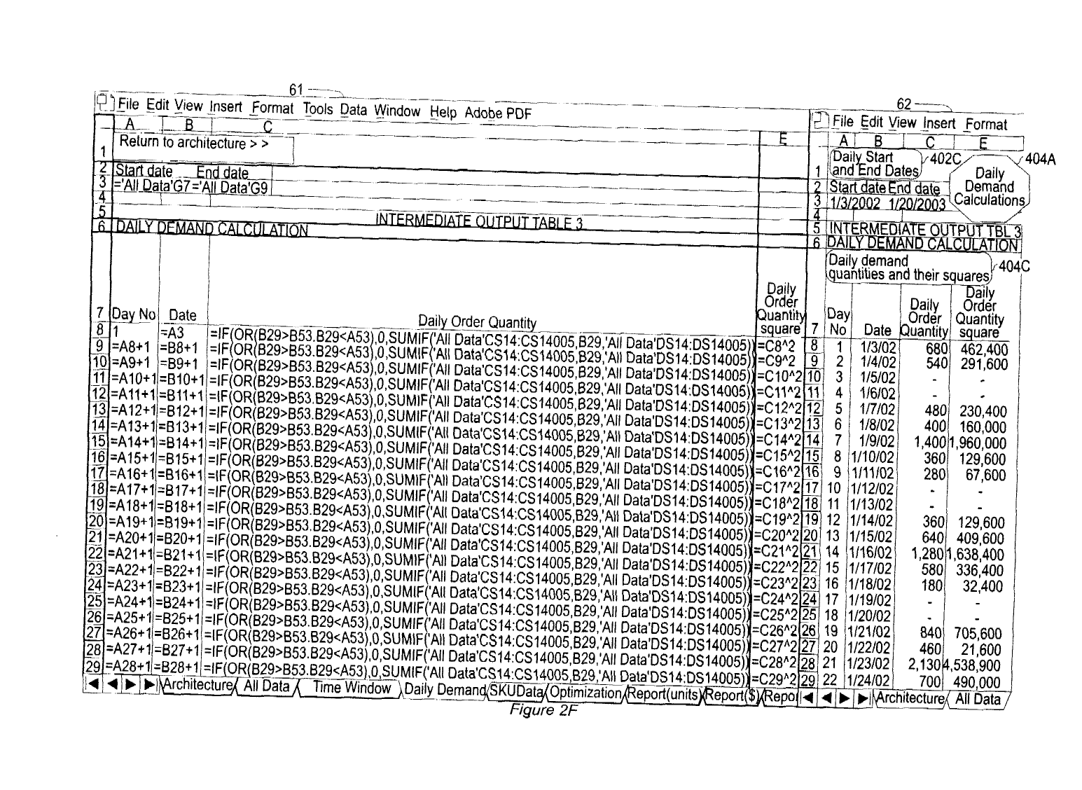

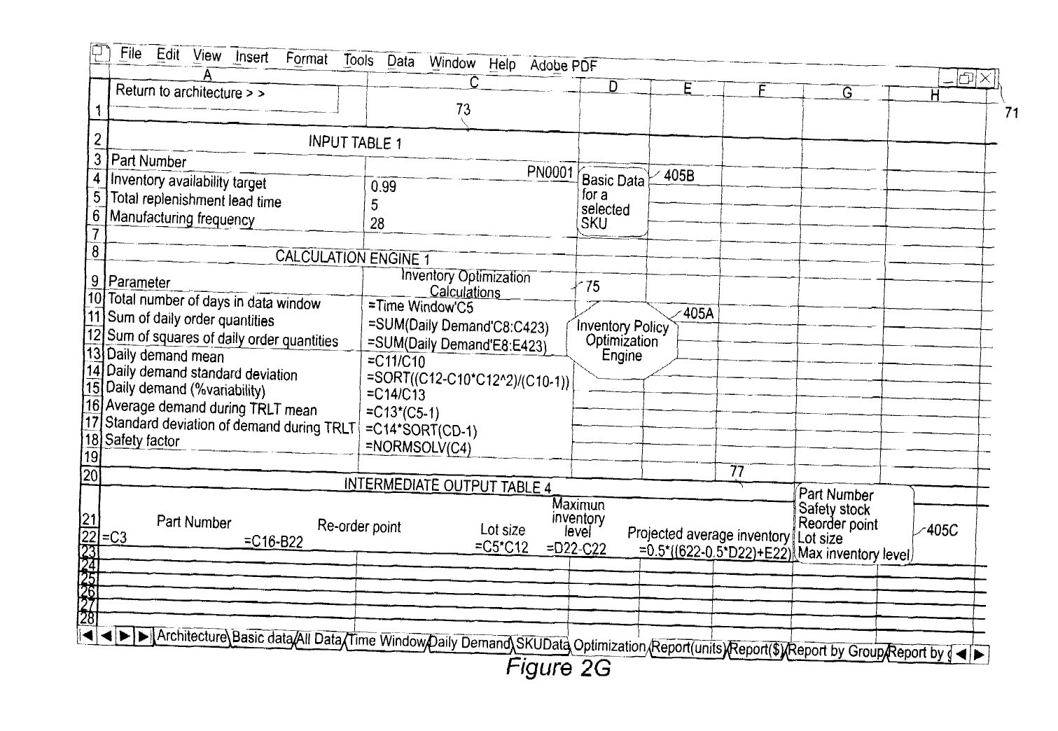

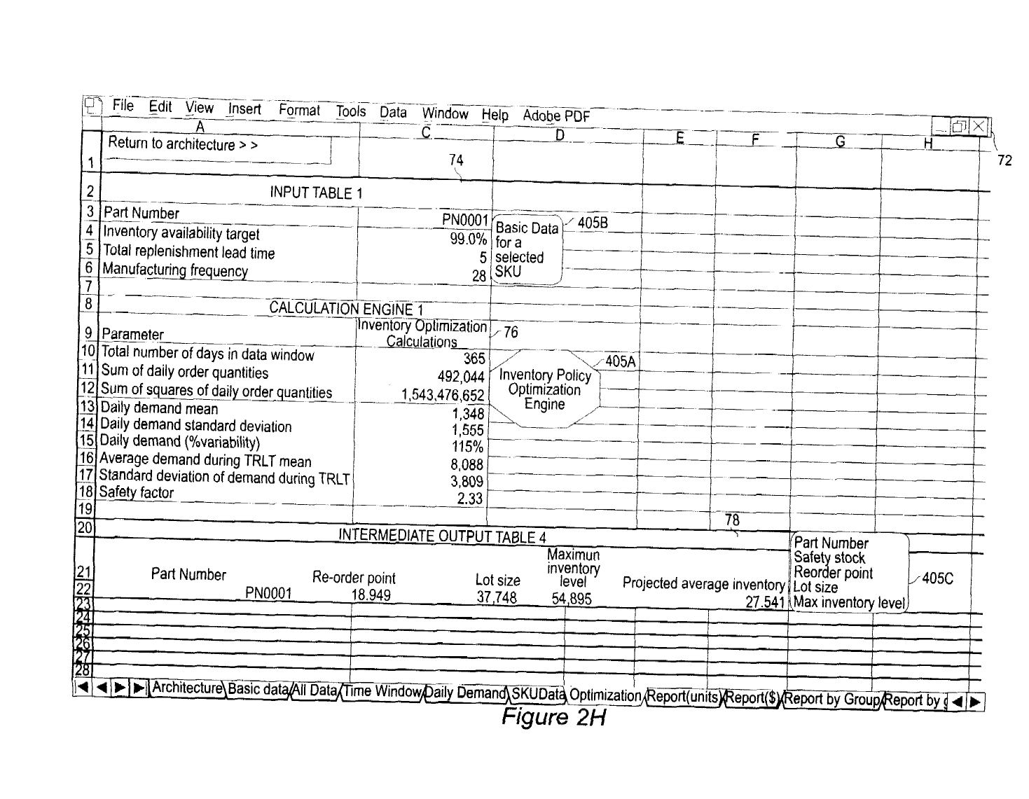

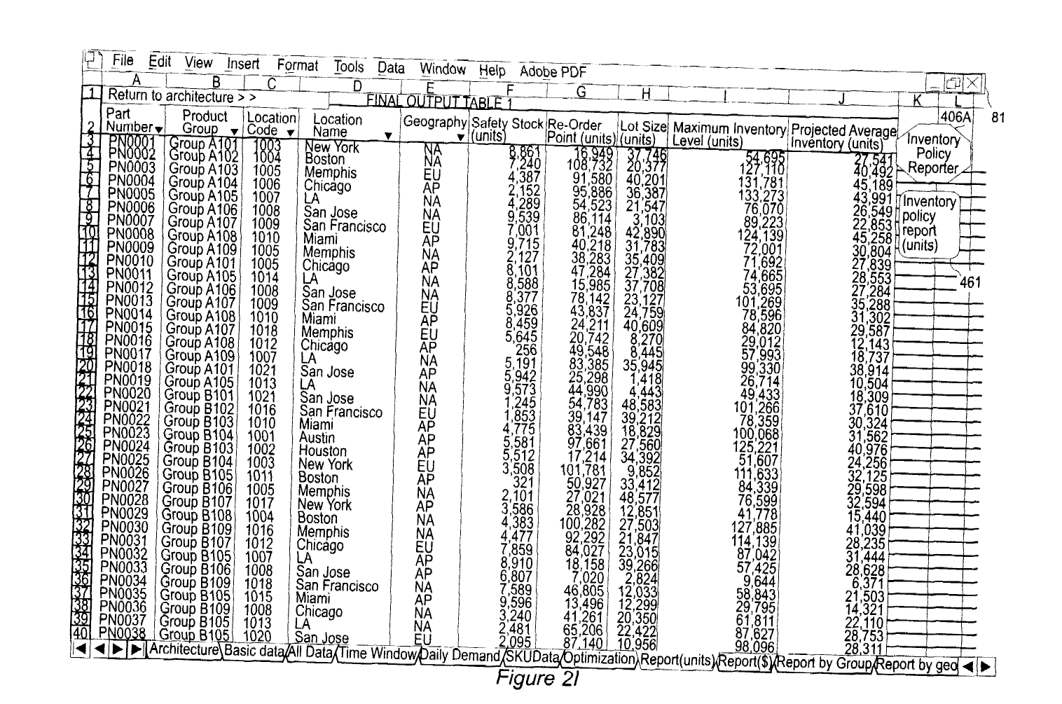

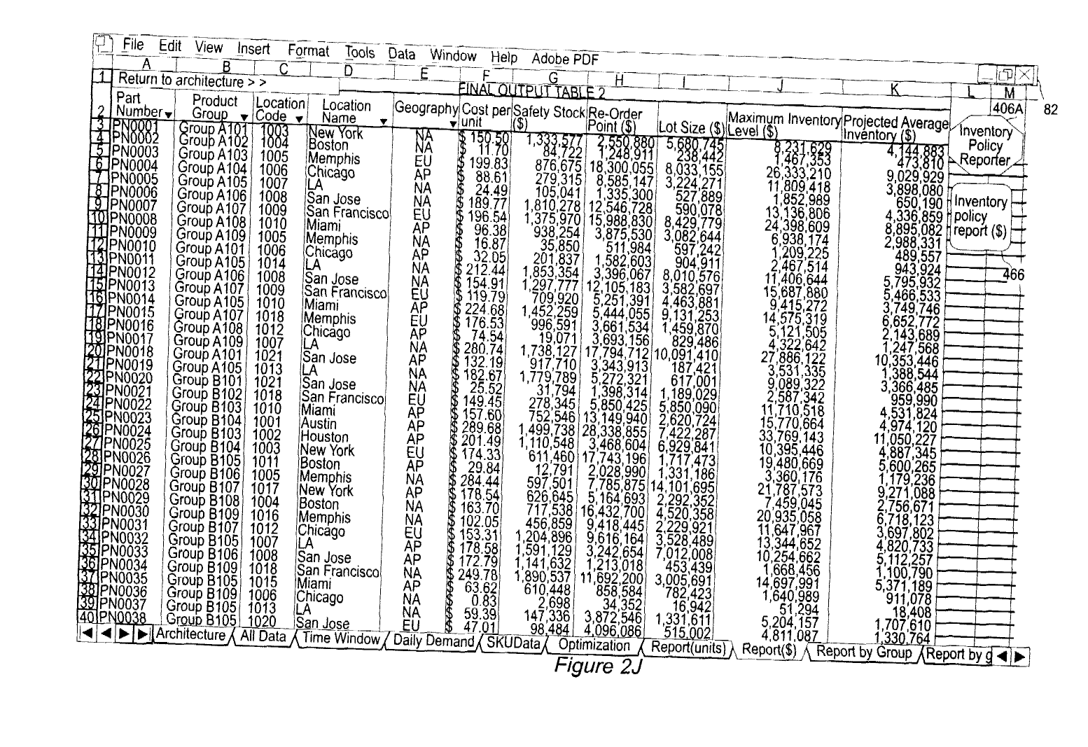

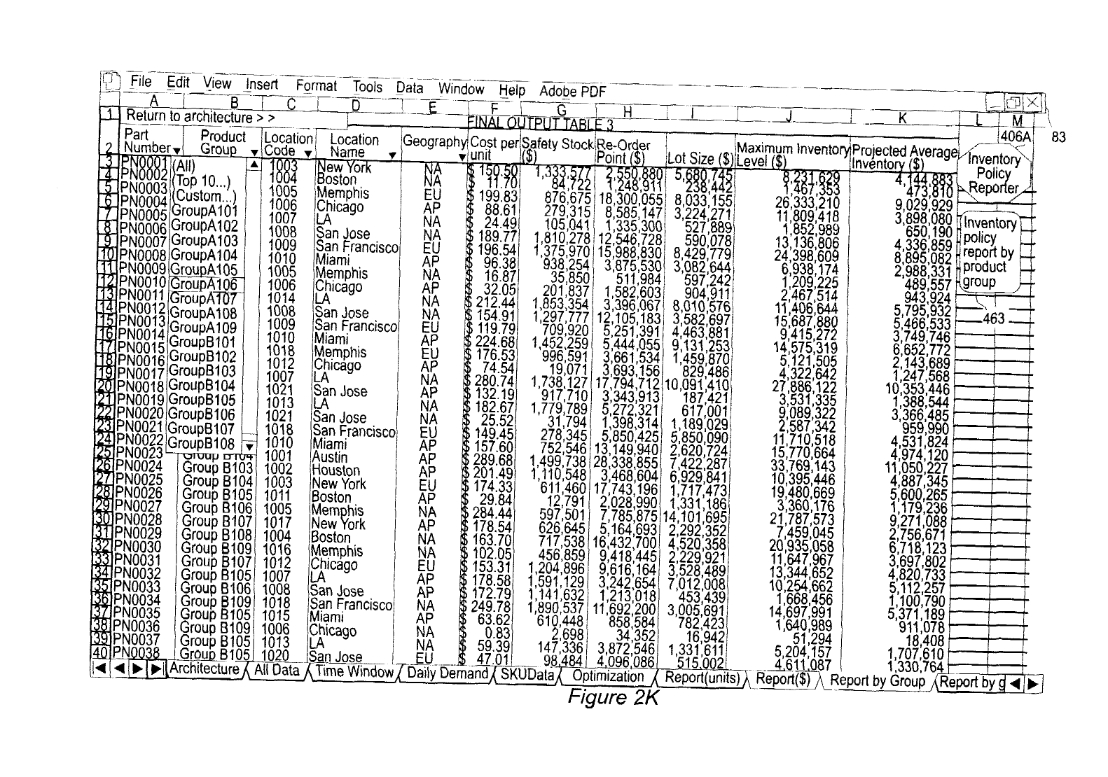

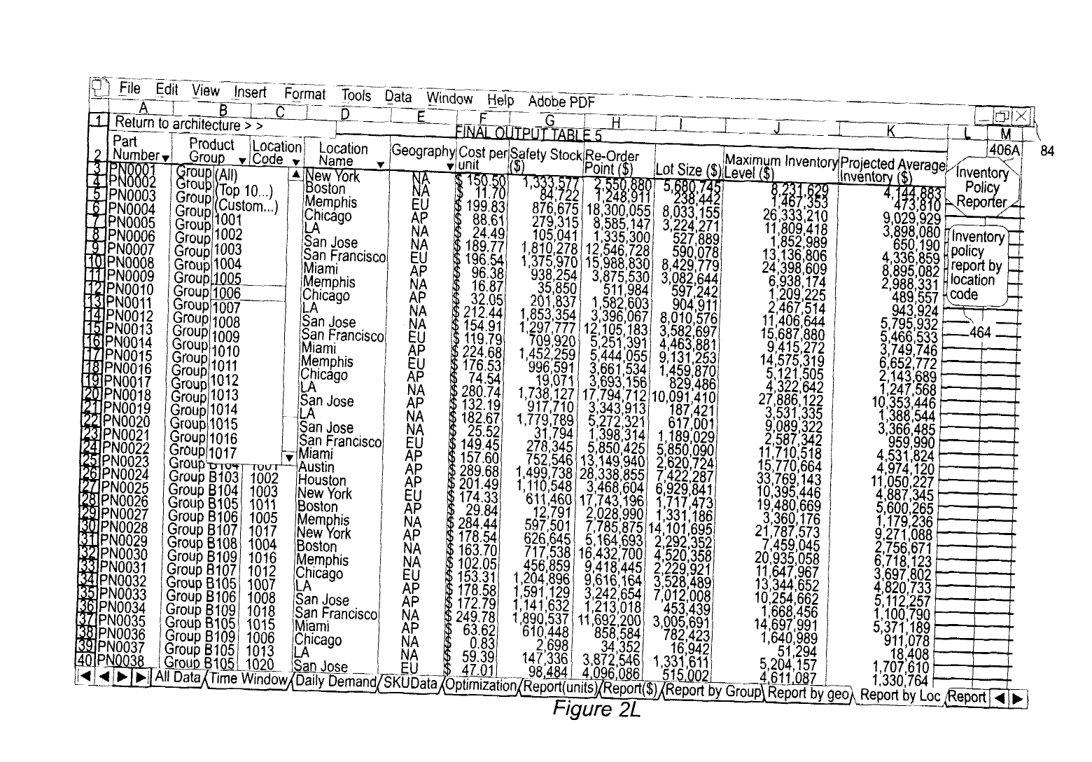

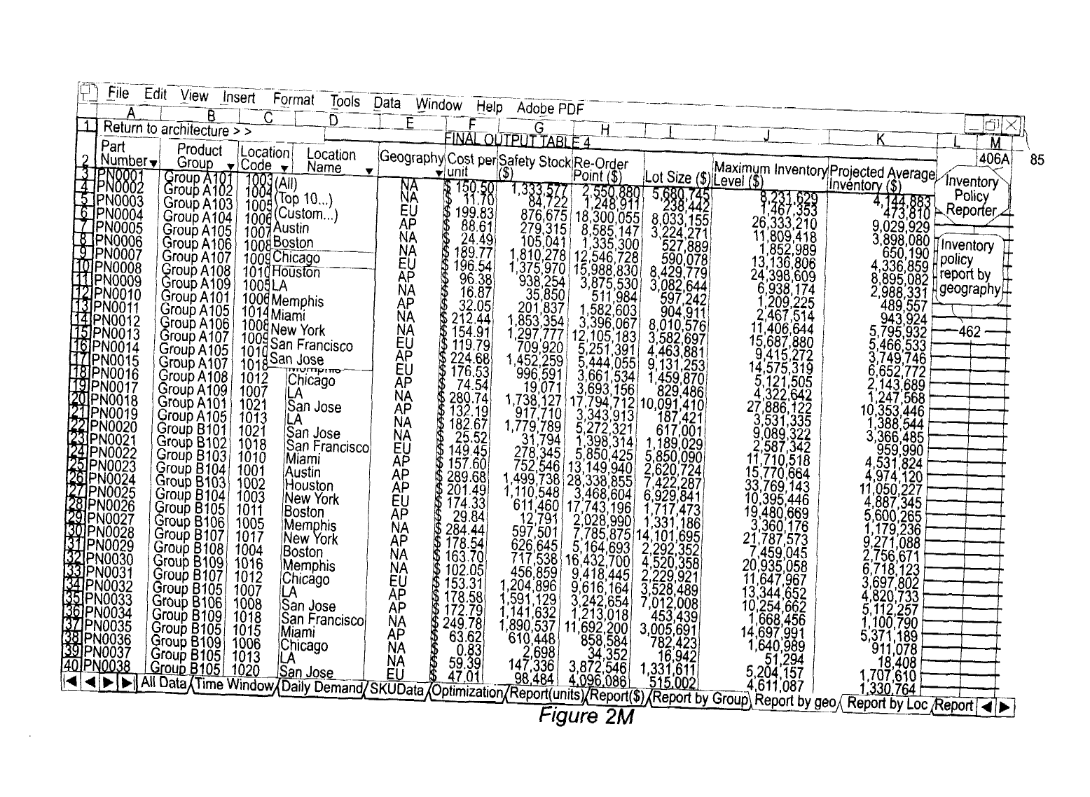

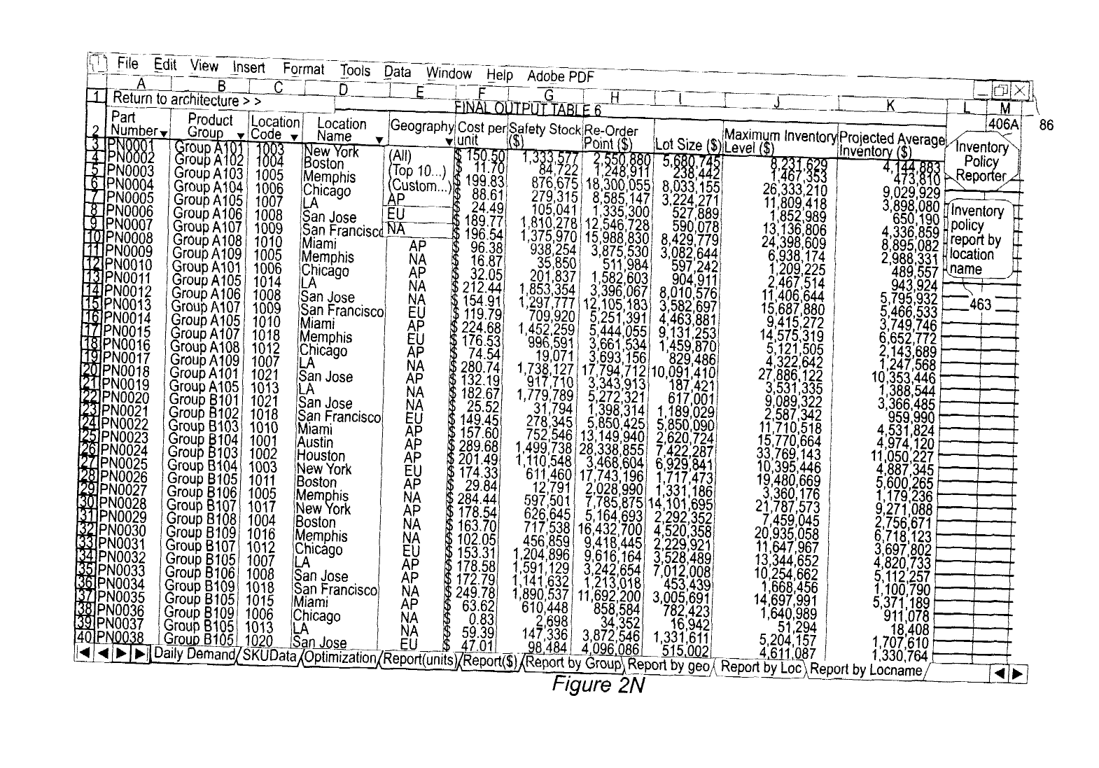

The foregoing steps are integrated into an iterative process which may be understood by reference to the drawings, and more particularly to FIG. 1, to which we now turn. FIG. 1 shows a flow diagram of the methodology used to develop a BPDB 120 and RM 130 in accordance with the invention. More detailed examples of a BPDB and RM will be described later in connection with FIG. 2A through 2N. The BPDB 120 has the following types of objects:
Data sources (Exogenous data inputs created outside the BP Scope and used within the BP Scope);
Data sinks (Exogenous data outputs required outside the BP Scope and produced inside the BP Scope);
Computation tasks (sub-processes which must have data flows into them and which produce data flows out of them);
Performance monitors (these objects must have data flows into them, outgoing data flows are optional);
Data transforms (these objects are simple forms of computation tasks, having data flows in and out; these objects may be just reformatting tasks needed for detailed design, or, may have logic associated with aggregation of data, etc.);
Data repositories (data stores within the BP Scope);
Data flows (representing data flowing between objects within the BP Scope); and
Data flow arcs (representing data flowing from a data source to a data sink).

The computation tasks can be Business Processes themselves and may have their own Business Process Design. Hence the BPDB can have nested levels 124. The BPDB must specify the “data model” of every object. An object's data model defines the precise data attributes that the object requires as input and produces as output. Each data flow arc of the BPDB must specify the data attributes contained in that flow. A BPDB is “feasible” if and only if, for every object in the BPDB, there are data flows into and out of the object with matching data attributes corresponding to the data model for that object.

In many cases, the business environment will impose constraints on the design. These constraints can apply to any of the objects. In particular, the computation tasks may be constrained by the software tools available to perform these tasks. The constraints can be with regard to data models or computational ability to generate the desired data flows.

The method of this invention involves the iterative development of the BPDB 120 corresponding to a Business Process along with a Representative Model 130 (RM) for this Business Process. The RM 130 is dynamically modified as described hereafter, but it begins as a scaled down version of the business environment along with the BPDB objects and data flows 123. It is a working model of the BPDB 120 and, as such, can be evaluated Since the methodology is iterative, the RM 130 is implemented with a tool which should be flexible and robust to accommodate design changes in the BPDB 120. The goal of the RM 130 is to have a functioning model of the business in which Process Designers can view the design in progress. The RM 130 will have actual data inputs 131 and outputs 132, and actual computational functions and data flows 133 to serve as surrogates for the corresponding objects in the BPDB 120. These surrogate computation functions are models of the computation task objects or performance monitors which are objects 123 in the BPDB 120.

A good example of a tool for building an RM is a computer software spreadsheet. The data sources, data sinks, and data repositories can be modeled as data on worksheets. The computation tasks and performance monitors can be modeled as simple macros.

Step 1 in the invention's methodology is to define (or refine) the scope of business activity (BP Scope). Step 2 is to define the business environment, which means identifying goals, metrics, performance targets, business criteria and constraints. Then in step 3 data sources 121 and data sinks 122 are defined for the BPDB 120. In step 4 suitable data inputs 131 are created for the RM 130. In practice it will be necessary to have multiple scenarios, each with appropriate data inputs 131 and expectations for data outputs 132, to run through the RM. In this step 4 it is necessary to ask whether the RM data is rich enough to capture the business environment specified in step 2, and whether a functioning prototype with this data will be sufficient for proof of the design in terms of: goals, metrics, performance targets, business criteria, and constraints specified in step 2. If not, then continue to develop the RM data and, if the business environment is not well defined, return to step 2 to refine the business environment definition.

In step 5 add objects and data flows 123 in order to refine the BPDB 120. The objects do not need to be rigorously defined at first, but should capture the essence of what the objects do. The details can be filled in later. Computation tasks which can themselves be Business Process Designs and can therefore have their own BPDB to specify the flows and computations within the computation, can be “roughed in”, as shown by 124 and a corresponding surrogate 134 in the RM 130. In step 6 the BPDB is reviewed for feasibility, that is, do the data models of the objects match the data flows and are the constraints set in step 2 satisfied? If not, then return to step 5.

In step 7 detail is added to the RM so that it captures the design in the BPDB. This task can involve establishing surrogate computational calculations which perform according to the BPDB. The level of detail in the RM should be consistent with that in the BPDB, as determined in step 8. If the RM does not contain the level of detail specified in the data models for objects 123 in the BPDB 120, then return to step 6. In step 9 the RM is analyzed to determine if the BPDB satisfies the objectives outlined in the Business Environment, in terms of meeting goals and measuring metrics via Performance Monitors. If not, then return to step 5. Note that analysis of the RM may involve executing the model in various scenarios. The scenario's should reflect the business environment. Finally, in step 10, a determination is made whether the BPDB contains enough detail so that it can be implemented by an IT system developer. If so, then the BPDB and the RM are developed enough to serve as an unambiguous requirements document and the methodology is done 11. If not, then return to step 5.

The invention's methodology may be further understood by reference to FIGS. 2A through 2N, which show an illustrative example of an implementation of the invention. The implementation is about designing an inventory optimization process. The charts in the figures show all necessary steps, inputs, outputs, and the calculations without any ambiguity in a concise manner. FIG. 2A shows the articulation of the initial four steps that are outlined in FIG. 1A. Item 21 provides a definition for the scope of the business, the first step in the process, which in this case is a process of optimal inventory policy calculation and reporting. Item 22 contains a definition of the business environment, the second step in the process. Item 23 identifies inputs (item 23A), intermediate outputs (item 23B) and outputs (item 23C). These show the third step in the process. Item 24 corresponds to the fourth step in the process. Step 4 is detailed in FIG. 2B, which shows the data inputs, data outputs and computational functions and data flows of the Representative Model corresponding to the BPDB (whose data sources and sinks are shown in items 23A, 23B and 23C of FIG. 2A). FIGS. 2C through 2N show the formulae and numbers behind each of the objects (i.e. data inputs, data outputs and computational functions) shown in FIG. 2B.

Although process flow charts are very common in practice, and they give a general idea of the process design, they do not provide any specific information about the requirements and how the implementation has to be done. More specifically, they do not articulate the input/output data requirements in detail. They do not give details of what these data should look like, how they should be calculated, and how they should be reported. In practice, a separate document of requirements is created. This document tends to be cumbersome having to have all the details explained in text format. Usually descriptions provided by non-technical people have ambiguities from the perspective of technical IT people. Therefore, IT people have to ask for clarifications of these ambiguities from those who created the document. Often, this prolongs the process of understanding the requirements completely, and might cause errors in implementation.

FIG. 2B shows the main architecture that outlines all the elements of optimal inventory policy calculation and reporting. It lays out blocks for inputs, intermediate calculations, final outputs and the blocks of calculations that have to be done. Block 402 provides a time window input 402B which feeds calculation 402A of data start and end dates 402C. Order data for a selected Stock Keeping Unit (SKU) 403B in Block 403 serves as input to order data processor 403A, which outputs the square of order quantities and within time window 403C. The outputs of Blocks 402 and 403 serve as inputs to daily demand calculations 404A in Block 404, which outputs daily demand quantities and their squares 404C. This, in turn, along with basic data for a selected SKU 405B (taken from basic operational and financial data table 401 B), serves as input to an inventory policy optimization engine 405A in Block 405, which outputs the part number, safety stock, reorder point, lot size and max inventory level 405C by SKU. These outputs serve as inputs to an inventory policy reporter 406A in Block 406. Further inputs to the inventory policy reporter 406A are provided by basic operational and financial data table by all SKUs 401B. The inventory policy reporter 406A generates six inventory policy reports: a units report 461, and reports by geography 462, by product group 463, by location code 464, by location name 465, and an inventory policy report ($) 466.

A useful feature of the invention is that by clicking on each block in an RM (e.g. as shown in FIG. 2B), the user can go and see the data represented by each block and check all the necessary details of those data. In addition, by clicking on the calculation blocks, one can see the details of how the calculations are performed. There are two separate views of these calculations: a formula view, and a value view. The formula view displays the formulas and the value view displays the values that are coming out of the formulas. It will be noted that in the example shown in FIG. 2B computation functions within a block are given a suffix “A”, raw input data are given the suffix “B”, and calculated parameters (they may be inputs/outputs) are given the suffix “C”.

For instance, clicking on the block 401B displays a raw input table 31, as shown in FIG. 2C. Clicking on the objects in block 402 displays as shown in FIG. 2D, with both a formula pane 41 and a values pane 42. Similarly the objects in block 403 are displayed as shown in FIG. 2E, with both a formula pane 51 and a values pane 52. FIG. 2F displays formula pane 61 and values pane 62 for the objects in block 404. Clicking on the objects in block 405 displays a formula pane 71 as shown in FIG. 2G and a values pane 72 as shown in FIG. 2H. The inventory policy reports generated in block 406 by inventory policy reporter 406A are shown in FIG. 2I (units report 461), FIG. 2J (dollars report 466), FIG. 2K (by product group 463), FIG. 2L (by location code 464), FIG. 2M (by geography 462), and FIG. 2N (by location name 465). By closely examining these tables of reports, IT people can easily and quickly understand how the reporting will have to be implemented in an automated system. It should be emphasized that the RM provides a blueprint for effective communication of requirements between business unit and IT professionals. The RM is not itself the system that is constructed by the IT professionals from the blueprint.

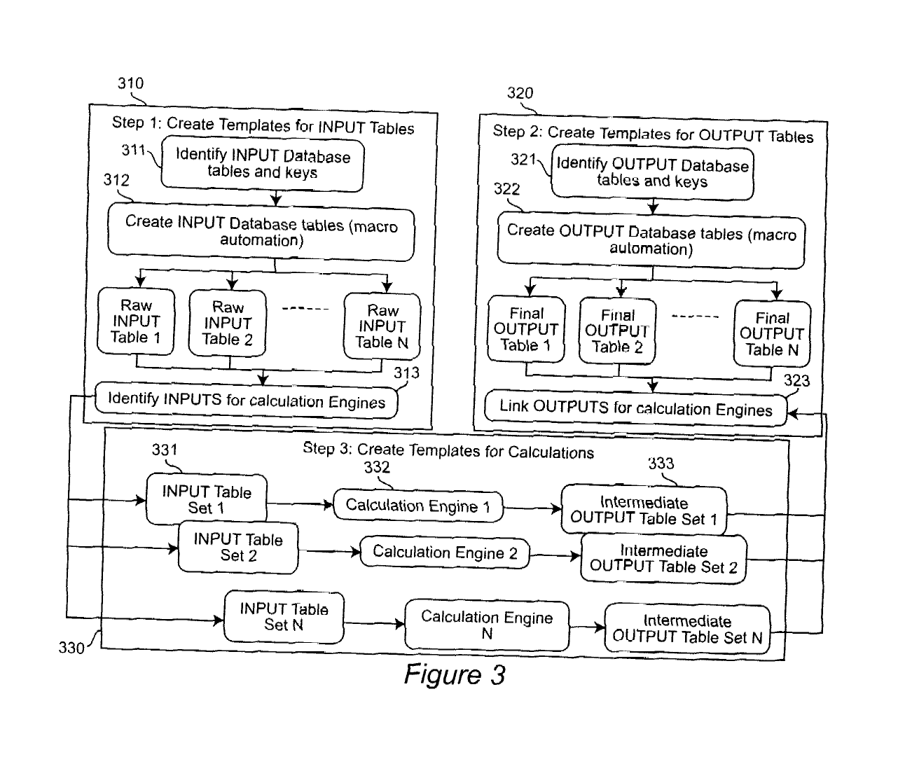

FIG. 3 shows how to create database tables based on the process design outlined. In step 1 (shown in block 310) input tables are identified with keys that relate them to other tables (block 311). All fields for each table are identified from the input parameters that are needed in the process design. Then tables are created in the database software being used (block 312). A macro can be written to create these tables automatically once the tables are specified in terms of their parameters, value formats, and the key field. In the last step of input table creation (block 313), inputs are selected for calculation engines and put in INPUT tables that are ready to feed the calculation engines.

In step 2 (shown in block 320), all output tables are identified with key fields (block 321). All fields for each table are identified from the intermediate parameters and output parameters that are given in the process design. Then OUTPUT tables are created in the database software being used through a macro that can automate this creation process. In the last step of OUPUT table creation (block 323), outputs that are coming out of calculation engines are linked to the output tables.

In step 3 (shown in block 330) input tables of all calculation engines and their output tables are created. The input tables 331 are created from the data available in raw input tables that are created in step 1. The outputs 333 of calculation engines 332 are called intermediate outputs because they are not necessarily used in the final output reported to the users. They are linked to the final outputs, however, and this closes the loop of table creation.

In the Inventory Optimization Process example described above, we identified all the database tables in FIGS. 2C through 2N. Each data block in the process design given in FIG. 2B is related to a database table. The designer of the process must take into account the database table creation as the next step. Therefore the designer needs to create data blocks in a way that is suitable for automating the database table creation through macro functionality of the database software to be used.

The methodology of the invention may also be understood by reference to an analogy with the methods of the construction industry. In that industry the task is to design a building which meets certain criteria. The BPDB would be analogous to the architectural blueprints for the building. When completed, the blueprint is a concise, unambiguous specification that can be used by the construction crew to construct the building. The generation of the design evolves through the iterative process of blueprint sketches which are analyzed for feasibility and performance objectives. The physical properties of existing materials will cause constraints on the design, just as the case with objects within the BPDB. The ultimate goal for the business process design is to create a process and supporting IT system that solves a business need, with minimal cost. Similarly, the customer of the building wants a structure that works at minimal cost. It is well known in the construction industry that, once construction starts, it is very costly to make changes to the design. Thus, in addition to concise blueprints, the designer may want to build a model of the finished building to help ensure that the end product will meet the performance criteria. This is now often done with the aid of computer models which incorporate the attributes of the various building materials which are available to use in the construction.

In the realm of Business Process Re-engineering, such well defined blueprints of a process design are rarely created, and construction of the IT system will begin without a clear, concise specification of how to build it. Further, there is often no Representative Model (RM) to guarantee that the design is feasible or will even solve the business need.

The advantage of this methodology is that it provides a “workbench” for a business unit to generate a well defined “blue print” of their business process. It is the RM and the correspondence between the RM and the BPDB which assure that the BPDB is well defined. The RM requires numeric data as input and tests with numeric results the BPDB, thereby enabling the business unit to walk through their business process end-to-end without ambiguities. The methodology gives a clear picture of how things are done and the role and goal of each task in relation to the other. It shows examples of how data look like at each step of the process. It also allows performance analysis through calculation engines that are attached to the model.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for specifying information technology (IT) requirements for a business process, comprising the steps of:
creating a representative model (RM) of the business process, the model replicating numerical output measures used by managers to measure performance of the business process;
providing the representative model with raw inputs and calculation engines for producing intermediate outputs for replicating said numerical output measures;
evaluating whether the representative model is a viable prototype of the business process, and whether it provides desired performance of output measures, and whether its detail is sufficient to enable IT professionals to build a system implementing the prototype;
if the representative model is not a viable prototype, or if it does not provide desired performance of output measures, or if its detail is not sufficient, adding detail to the representative model and returning to the evaluation step.

2. A method for specifying information technology (IT) requirements for a business process as in claim 1, wherein said creating step further comprises the step of defining a design blueprint for the business process (BPDB), the BPDB being comprised of data sources, data sinks, and computational tasks modeled by the RM.

3. A method for specifying information technology (IT) requirements for a business process as in claim 2, wherein said providing step further comprises the steps of:
creating templates for input tables, said templates being used to identify inputs for calculation engines;
creating templates for output tables;
creating templates for the calculation engines, said calculation engines producing intermediate outputs linked to said output tables.

4. A method for specifying information technology (IT) requirements for a business process as in claim 3, wherein the step of adding detail to the representative model includes the step of establishing a surrogate computational calculation which performs according to a computational task in the BPDB.

5. A method for specifying information technology (IT) requirements for a business process as in claim 3, wherein the step of adding detail to the representative model includes the step of generating a subordinate BPDB and RM to more accurately model a particular computational task.

6. A method for specifying information technology (IT) requirements for a business process as in claim 2, wherein the step of evaluating the viability of the RM includes ensuring that the level of detail of the RM matches the level of detail of the BPDB.

7. A method for specifying information technology (IT) requirements for a business process as in claim 2, wherein the step of evaluating the viability of the RM includes analyzing the RM to determine if the BPDB satisfies objectives defined for the business process.

8. A method for specifying information technology (IT) requirements for a business process as in claim 1, wherein a spreadsheet is used to create the representative model.

9. For an operational process having well defined goals, metrics, performance targets, and constraints, a method of specifying information technology (IT) requirements, said requirements to be used by IT professionals to build an automated system for the operational process, comprising the steps of:
defining a process design blueprint for said operational process, said design being comprised of model objects connected by data flows;
defining data sources and data sinks for said model objects in said operational process;
using a numerical modeling tool to create data inputs and data outputs for a representative model of said operational process, said representative model implementing computational tasks corresponding to said model objects so as to generate said data outputs from said data inputs, said data inputs and data outputs being responsive to said well defined goals, metrics, performance targets, and constraints used by business managers of said operational process;
if said process design blueprint is not detailed enough to specify requirements usable by IT professionals, performing the further steps of:
adding model objects and data flow arcs to said process design blueprint;
creating with said numerical modeling tool further data inputs and data outputs, and implementing with said numerical modeling tool further computational tasks, said creating and implementing corresponding to said additional model objects and data flow arcs;
expanding said computational task objects by making surrogate calculations for said tasks or generating separate process design blueprints for said tasks, and
returning to said step of using a numerical modeling tool to create data for a representative model of said operational process;
evaluating said representative model against said goals, metrics, performance targets and constraints.

10. The method of claim 9, wherein said numerical modeling tool is a software spreadsheet.

11. The method of claim 9, wherein one or more of said well defined goals, metrics, and performance targets are modified in response to said evaluation step.

12. The method of claim 9, wherein the step of creating data inputs and data outputs for a representative model of said operational process further comprises the steps of:
creating templates for input tables, said templates being used to identify inputs for calculation engines;
creating templates for output tables;
creating templates for the calculation engines, said calculation engines producing intermediate outputs linked to said output tables.

13. The method for evaluating the representative model in claim 1, wherein the evaluation consists of randomly creating values of input parameters, including exogenous variables that impact business performance, and calculating output measures by invoking surrogate calculation engines.
